(19) United States
(12) Patent Application Publication
(10) Pub. No.: US 2023/0368343 A1
(43) Pub. Date: Nov. 16, 2023

(54) GLOBAL MOTION DETECTION-BASED IMAGE PARAMETER CONTROL

(71) Applicant: META PLATFORMS TECHNOLOGIES, LLC, Menlo Park, CA (US)

(72) Inventors: Mooyoung SHIN, Hayward, CA (US); Hao SUN, Sunnyvale, CA (US); Andres Felipe MARQUEZ MOSQUERA, Foster City, CA (US)

(21) Appl. No.: 17/666,992

(22) Filed: Feb. 8, 2022

(51) Int. Cl. G06T 5/00; G06T 7/20; G06V 40/16; G06V 20/40; H04N 5/77; H04N 5/235; H04N 5/243; G06V 10/74

(52) U.S. Cl. CPC G06T 5/006; G06T 7/20; G06V 40/16; G06V 20/41; H04N 5/77; H04N 5/2351; H04N 5/243; G06V 10/761; G06T 2207/30201; G06T 2207/10016

(57) ABSTRACT

In various embodiments a computer-implemented method comprises generating, for a current video frame, a set of face motion data indicating whether a set of one or more faces detected in the current video frame has moved since a preceding video frame, generating a set of device motion data associated with one or more movements of an image capture device when capturing the current video frame, and generating a set of global motion data based on the set of face motion data and the set of device motion data, where the set of global motion data identifies a unique face motion when the set of face motion data indicates at least one face in the set of one or more faces has moved, and the set of device motion data indicates less than a threshold amount of motion of the image capture device when capturing the current video frame.

### BACKGROUND

### Field of the Various Embodiments

Embodiments of the present disclosure relates generally to image processing and, more specifically, to global motion detection-based image parameter control.

### Description of the Related Art

Various video capture devices, such as digital video cameras, include a suite of image correction and compensation components to adjust images captured by image sensors. For example, a video processing device can include auto correction software, such as auto exposure (AE) and auto white balance to adjust parameters of a captured image or video frame, such as brightness and individual color values, in order to provide high-quality images. For example, a given video frame in a video sequence may have a significant difference in a given parameter compared to previous video frames, such as brightness relative to a preceding video frame. The video processing device implements the auto correction software over a successive set of video frames to mitigate the significant difference in brightness, converging to a steady-state level of brightness. Some video processing devices use the auto correction software to modify a set of video frames to closely emulate the range of a human eye such that the lighting in a given video frame appears more natural, where the image correction techniques converge to a brightness level or color balance level that enables a user to view a video sequence clearly.

Some conventional image processing devices improve image correction components by providing face data, where the image correction components focus on the location of faces and face movements of people in a video frame in order to adjust the image parameters to cause the faces to be in proper focus and lighting. In such devices, the image correction components track the location of faces and modify a given video frame to compensate for lighting areas around the location of faces within the frame.

One drawback of conventional video processing devices using these image correction components is that the image correction components would adjust image parameters in a given video frame that overcompensate or undercompensate for detected errors based on the detected face data. In particular, a conventional video processing device computes face motion data to determine the motion of a face over a sequence of video frames. The image correction components would control the convergence speed of image parameters over the sequence based on the face data in order to control how the image correction components adjusted the video frames in the sequence. However, such techniques would lead to slow convergence speeds when a subject moves rapidly. For example, when an image capture device moves from indoors to outdoors, the image correction components of an image processing device detects that a subject is moving based on detected face data and responds by slowing the convergence speeds for the brightness and/or relative color levels to reach steady-state. However, slowing the convergence speed leads the image correction components to adjust multiple video frames in the sequence slowly, causing the image correction components to generate adjusted frames that include errors, such as overexposure or underexposure. As a result, the image processing device generates low-quality video frames that are difficult for users to view.

As the foregoing illustrates, what is needed in the art are more effective techniques for video processing device to correct captured images.

### SUMMARY

In various embodiments, a computer-implemented method comprises generating, for a current video frame, a set of face motion data indicating whether a set of one or more faces detected in the current video frame has moved since a preceding video frame, generating a set of device motion data associated with one or more movements of an image capture device when capturing the current video frame, and generating a set of global motion data based on the set of face motion data and the set of device motion data, where the set of global motion data identifies a unique face motion when the set of face motion data indicates at least one face in the set of one or more faces has moved, and the set of device motion data indicates less than a threshold amount of motion of the image capture device when capturing the current video frame. At least one technological advantage of the disclosed techniques relative to the prior art is that the image processing application enables a video processing device to distinguish movements of faces in a video frame to movements of the device capturing the video frame. In particular, by determining the movements of detected faces in a sequence of video frames and separately determining device motions that occurred when capturing the sequence of video frames, the image processing application can identify unique face motions in a video frame compared to global motions that are also due to the image capture device moving. The image processing application thus filters false positive face movements and can perform correction operations based on whether a unique face motion is detected. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates an image processing system according to one or more embodiments.

FIG. 2 illustrates an image correction technique of the image processing system of FIG. 1 modifying a captured video frame, according to one or more embodiments;

FIG. 3 illustrates a technique of the face motion detector application of the image processing system of FIG. 1 detecting motions of subjects and devices, according to one or more embodiments;

FIGS. 4A-4B illustrate a set of face coordinates generated by the face detection module included in the image processing system of FIG. 1, according to one or more embodiments;

FIG. 5 illustrates a technique of the face motion analyzer of the image processing system of FIG. 1 detecting face motions of subjects in a frame, according to one or more embodiments;

FIG. 6 illustrates a technique of the signal separator of the image processing system of FIG. 1 determining whether a global motion has occurred, according to one or more embodiments;

FIG. 7 illustrates a graph generated by a signal combiner included in the image processing system of FIG. 1 used to determine a shrinking percentage for a frame, according to one or more embodiments;

FIG. 8 is a flow diagram of method steps of the image processing system of FIG. 1 modifying a captured video frame, according to one or more embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### Overview

In various embodiments, an image processing application receives video frames from an image capture device and generates a set of modified video frames for viewing via one or more display devices. The image processing application includes a frame correction application that executes one or more image correction techniques in order to modify the image parameters of a given video frame generated by the image capture device. The image processing application also includes a face motion detection application that receives face data, including separate sets of facial coordinates for each detected face in a given video frame, and determines whether the given video frame includes face motion. The face motion detector application also receives sensor data and/or scene change data and determines whether the given frame includes device motion. The face motion detector application detects face motions in the given video frame and distinguishes unique face motions in the video frame from global motions that at least partially are due to motions of the image capture device.

Upon determining whether a face motion and/or a device motion was included in a given video frame, the face motion detector application provides a set of global motion data to the frame correction application. The global motion data includes face data and the data association with any detected face motion or device motion. Based on the values included in the global motion data, the frame correction application modifies the frame with a set of image correction parameter values. Applying the image correction parameter values generates a modified video frame that enables a video sequence of frames to converge to a steady-state level.

In particular, when the global motion data identifies a unique face motion in a video frame (e.g., determining that no device motion is present within the video frame), the frame correction application focuses on the areas of the video frame corresponding to a set of face coordinates and generates a set of image correction parameter values in order to modify the parameters of the video frame to compensate for lighting changes proximate to the face coordinates. In contrast, the face motion detection application determining the presence of device motion in the video frame enables the frame correction application to filter “false positive” face motions; in such instances, the frame correction application uses image correction parameter values based on the entire video frame to compensate for lighting errors present in the entire video frame.

### System Overview

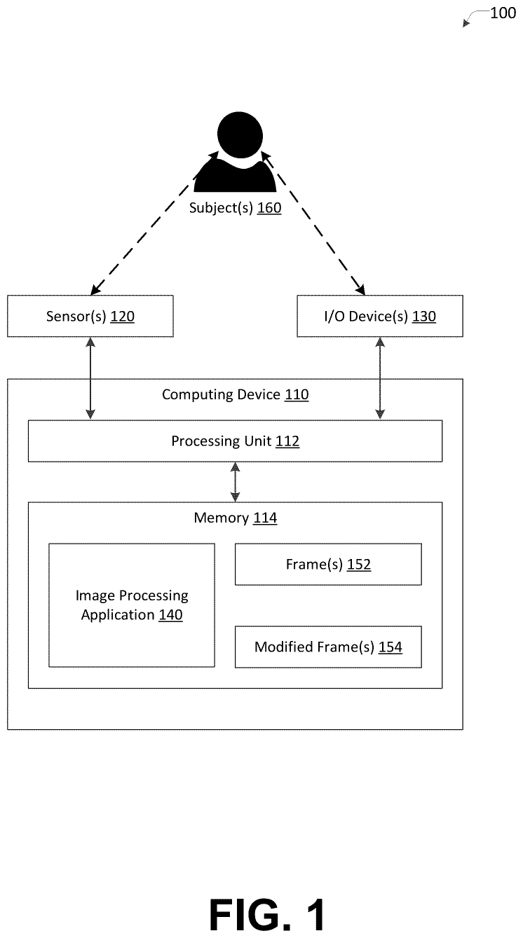

FIG. 1 illustrates an image processing system 100 according to one or more embodiments. As shown, and without limitation, the image processing system 100 includes a computing device 110, sensor(s) 120, and input/output (I/O) devices 130. The computing device 110 includes a processing unit 112 and a memory 114. The memory 114 includes an image processing application 140, frame(s) 152 (e.g., 152(1), . . . 152(n−1), 152(n)), and modified frame(s) 154 (e.g., 154(1), . . . 154(n−1), 154(n)).

In operation, the image processing system 100 generates a video frame 152 that includes one or more subject(s) 160. The image processing application 140 modifies one or more frames 152 to generate a set of modified frames 154, where the image processing application 140 generates a set of image correction parameter values to adjust one or more image parameters of the frames 152 and produce the modified frames 154. For example, the image processing application 140 can perform various auto exposure (AE), auto white balance (AWB), and other image correction techniques to generate the modified frame 154. In some embodiments, the image processing application 140 can generate the image correction parameter values based on the movement of the one or more subjects 160 and/or the sensor(s) 120.

The sensor(s) 120 include one or more devices that detect positions and/or speeds of objects in an environment by performing measurements and/or collecting data. For example, the sensors 120 can include one or more image sensors that can acquire visual data that indicates the positions of the subjects 160 in an environment. In another example, the sensors 120 can include an accelerometer that acquires rotational axis values (e.g., pitch, roll, yaw) of the computing device 110 and/or the visual sensors 120.

In some embodiments, the one or more sensors 120 can be coupled to and/or included within computing device 110. In some embodiments, computing device 110 may receive sensor data via the one or more sensors 120, where the sensor data reflects the position(s) and/or orientation(s) of one or more objects within an environment. The position(s) and/or orientation(s) of the one or more objects may be derived from the absolute position of the one or more sensors 120, and/or may be derived from a position of an object relative to the one or more sensors 120. Processing unit 112 executes the image processing application to generate a set of video frames 152 and/or a set of modified video frames 154 in the memory 114.

In various embodiments, the one or more sensors 120 can include optical sensors, such RGB cameras, time-of-flight sensors, infrared (IR) cameras, depth cameras, and/or a quick response (QR) code tracking system. In some embodiments, the one or more sensors 120 can include position sensors, such as an accelerometer and/or an inertial measurement unit (IMU). The IMU can be a device like a three-axis accelerometer, gyroscopic sensor, and/or magnetometer. In addition, in some embodiments, the one or more sensors 120 can include audio sensors, wireless sensors, including radio frequency (RF) sensors (e.g., sonar and radar), ultrasound-based sensors, capacitive sensors, laser-based sensors, and/or wireless communications protocols, including Bluetooth, Bluetooth low energy (BLE), wireless local area network (WiFi), cellular protocols, and/or near-field communications (NFC).

As noted above, the computing device 110 can include processing unit 112 and memory 114. The computing device 110 can be a device that includes one or more processing units 112, such as a system-on-a-chip (SoC), or a mobile computing device, such as a tablet computer, mobile phone, media player, and so forth. Generally, the computing device 110 can be configured to coordinate the overall operation of the image processing system 100. The embodiments disclosed herein contemplate any technically-feasible system configured to implement the functionality of the image processing system 100 via the computing device 110.

The processing unit 112 can include a central processing unit (CPU), a digital signal processing unit (DSP), a microprocessor, an application-specific integrated circuit (ASIC), a neural processing unit (NPU), a graphics processing unit (GPU), a field-programmable gate array (FPGA), and so forth. In some embodiments, the processing unit 112 can be configured to execute the image processing application 140 in order to generate a frame 152 based on acquire visual sensor data, analyze the sensor data acquired by the one or more sensors 120 to determine the motion of the subjects 160 and/or the image sensor, and generate a modified frame 154 to correct for changes in image parameters of the frame 152.

In various embodiments, the processing unit 112 can execute the image processing application 140 to generate a set of frames 152 and/or modified frames 154. In various embodiments, the processing unit 112 can execute the image processing application 140 as part of a video capture service that generates a sequence of frames as part of a video. In some embodiments, the image processing application 140 performs various image correction and/or other image altering techniques to generate a set of modified frames 154. For example, the image processing application 140 can execute various image correction techniques to alter a current frame 152(n) by generating a corresponding modified current frame 154(n) that has different image parameters than the current frame 152(n). For example, the image processing application 140 could generate a modified current frame 154(n) that has a different brightness range than the brightness range for the current frame 152(n).

The memory 114 can include a memory module or collection of memory modules. The image processing application 140 within the memory 114 can be executed by the processing unit 112 to implement the overall functionality of the computing device 110 and, thus, to coordinate the operation of the image processing system 100 as a whole.

The input/output (I/O) device(s) 130 can include devices capable of receiving input, such as a keyboard, a mouse, a touch-sensitive screen, a microphone, and/or other input devices for providing input data to computing device 110. In various embodiments, I/O device(s) 130 may include devices capable of providing output, such as a display screen, loudspeakers, haptic actuators, and the like. One or more of I/O devices 130 can be incorporated in computing device 110, or may be external to computing device 110. In some embodiments, computing device 110 and/or one or more I/O device(s) 130 may be components of an advanced driver assistance system.

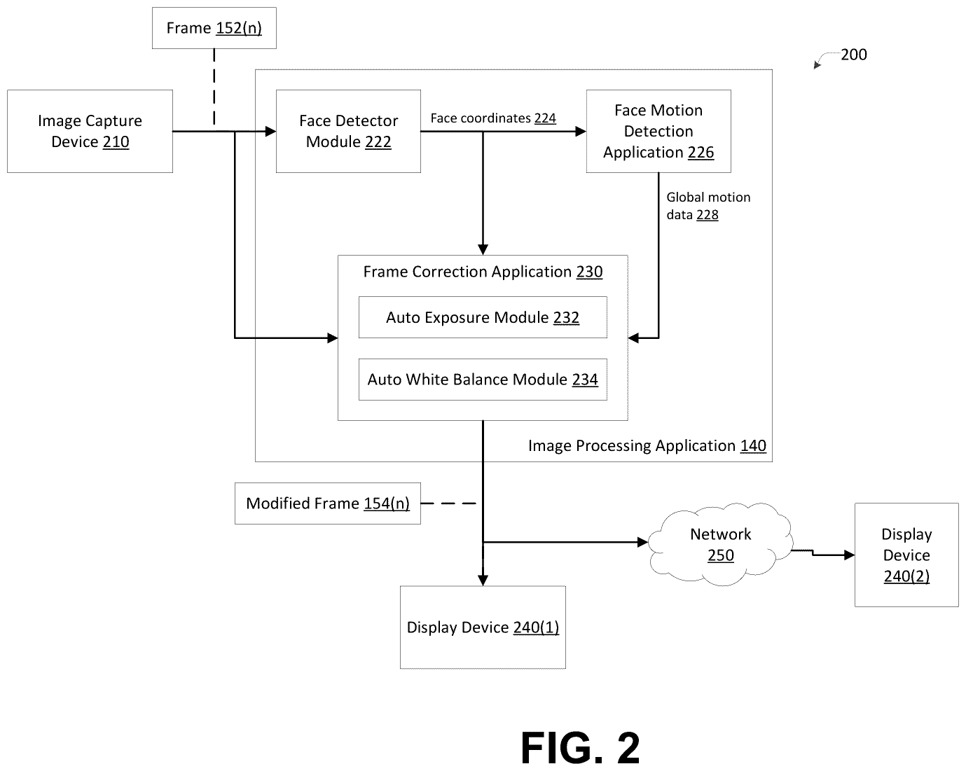

FIG. 2 illustrates an image correction technique of the image processing system 100 of FIG. 1 modifying a captured video frame, according to one or more embodiments. As shown, and without limitation, the image correction technique 200 includes an image capture device 210, the image processing application 140, display devices 240 (e.g., 240(1), 240(2), etc.), and a network 250. The image processing application 140 includes a face detector module 222, a face motion detection application 226, and a frame correction application 230. The frame correction application 230 includes an automatic exposure (AE) module 232, and an automatic white balance (AWB) module 234.

In operation, the image processing application 140 receives a sequence of video frames 152 (e.g., 152(1)-152(n)) from the image capture device 210. When receiving a current frame 152(n), the image processing application 140 processes the current frame 152(n) to identify a set of face coordinates 224, as well as a set of global motion data 228 associated with the movement of the image capture device 210 and/or the detected faces. The frame correction application 230 executes various operations to generate the modified current frame 154(n) that corresponds to the current frame 152(n). The image processing application 140 sends the modified current frame 154(n) as part of a video sequence to the one or more display devices 240(1), 240(2).

The image capture device 210 acquires visual sensor data from an environment. In various embodiments, the image capture device 210 includes one or more image sensors that acquire visual sensor data and generates a video frame 152 based on the acquired visual sensor data. In various embodiments, the image capture device 210 can acquire the visual sensor data while an audio capture device (not shown) acquires audio data as part of a video sequence. For example, the image capture device 210 can acquire visual data that includes the faces of three subjects 160 in an environment. In some embodiments, the image capture device 210 may generate the current frame 152(n) before sending the current frame 152(n) to the image processing application 140. Alternatively, in some embodiments, the image capture device 210 may send the visual data to the image processing application 140 to generate the current frame 152(n) before the image processing application 140 sends the current frame 152(n) to the face detector module 222 and/or the frame correction application 230.

The image processing application 140 analyzes a current frame 152(n) and performs various processing operations associated with the current frame 152(n). In various embodiments, the image processing application 140 can perform one or more image correction techniques to modify the image parameters of a current frame 152(n) in order to generate a modified current frame 154(n) that has a distinct set of image parameters. For example, the image processing application 140 can execute the auto white balance module 234 to generate a set of color adjustment values in order to generate a modified current frame 154(n) that has a different tone than the current frame 152(n).

In various embodiments, the image processing application 140 can track the motion of the subjects 160 over a sequence of video frames 152 and/or the motions of the image capture device 210 when acquiring the visual sensor data for the sequence of video frame 152. In such instances, the image processing application 140 can generate different image correction parameter values when generating the modified frame 154. In some embodiments, when the image processing application 140 detects a unique face motion by a subject 160 in a current frame 152(n), the image processing application 140 may slow the speed at which the sequence of video frames converges to a steady-state. For example, when the image processing application 140 detects one or more unique face motions a current frames 152(n), the image processing application 140 can control the image correction parameter values for a sequence of video frames 152 to slowly correct one or more image parameters in the sequence of video frames 152 and avoid correction defects, such as generating a modified frame 154 that is overexposed or is blurry.

Additionally or alternatively, when the image processing application 140 detects a global motion by both the subject 160 and the image capture device 210 in a sequence of frames 152, the image processing application 140 may generate image correction parameter values for the current frames 152(n) based on the entirety of the current frame 152(n). For example, the image processing application 140 can determine that significant differences in the image parameters of consecutive frames 152(n−1), 152(n) in a sequence is at least partially due to the image capture device 210 moving between the consecutive frames or due to a scene change that is captured by the image capture device 210. In such instances, the image processing application 140 can generate image correction parameter values based on the entirety of the current frame 152(n) and cause the sequence of frames 152 to converge back to a steady-state at a much greater speed. In some embodiments, the image processing application 140 may separate the unique face motion from the device face motion in order to provide a unique face motion portion included in the global motion data 228. For example, when the image processing application 140 detects a face motion beyond contributions from the device motion, the image processing application 140 can perform image correction techniques to further address the face motion.

The face detector module 222 analyzes the current frame 152(n) received from the image capture device 210 and determines whether the current frame 152(n) includes any faces. When the face detector module 222 identifies one or more faces in the current frame 152(n), the face detector module 222 generates one or more sets of face coordinates 224 corresponding with each detected face. In some embodiments, a given set of face coordinates 224 can correspond to a face region of interest (ROI) that the image processing application 140 uses for various operations, such as face tracking and/or face recognition. In such instances, the image processing application 140 can modify the sets of face coordinates 224 in order to more accurately track the face within a sequence of frames 152 and/or perform image correction techniques like auto focus, pan-and-scan, smile detection, and so forth.

The face motion detection application 226 determines a set of motions associated with a current frame 152(n) and generates a set of global motion data 228 that indicates the set of motions included in the given frames 152(n). In various embodiments, the face motion detection application 226 receives the set of face coordinates 224 from the face detector module and the sensor data from the one or more sensors 120 and generates a set of global motion data 228 that includes data indicating any detected face motion and any detected device motion. In some embodiments, the face motion detection application 226 generates global motion data 228 that includes modified sets of face coordinates. In such instances, the frame correction application 230 can use the modified set of face coordinates in lieu of the sets of face coordinates that the face detector module 222 provides.

The frame correction application 230 performs various techniques to generate a modified current frame 154(n) corresponding to the current frame 152(n), where the modified current frame 154(n) includes a set of corrections. For example, the frame correction application 230 can, upon receiving the global motion data 228, determine that the image capture device 210 moved when generating the current frame 152(n). In such instances, the frame correction application 230 may generate a set of image correction parameter values based on the image parameters included in the entire frame. In another example, the auto white balance module 234 included in the frame correction application 230 can, in response to the global motion data 228 indicating that the current frame 152(n) does not include device motion, generate a color adjustment values by weighing the color values within the sets of face coordinates more heavily than other portions of the current frame 152(n). In some embodiments, the image processing application 140 sends the modified current frame 154(n) to one or more display devices 240.

The display devices 240(1), 240(2) receive the modified current frame 154(n) generated by the image processing application 140. In various embodiments, one or more display devices 240 can receive the modified current frame 154(n) generated by the frame correction application 230 and can display the modified current frame 154(n) as part of a video sequence. For example, the display device 240(1) can be incorporated in a device that also includes the image capture device 210, while the display device 240(2) can be a remote device that also displays the video. In such instances, both display devices 240(1), 240(2) can display the modified current frame 154(n) as part of a video sequence. For example, the display device 240(1) can display the modified current frame 154(n) as a thumbnail image during a real-time communication session with the display device 240(2); the display device 240(2) can show at least the modified current frame 154(n) simultaneously.

The network 250 includes a plurality of network communications systems, such as routers and switches, configured to facilitate data communication between the image processing application 140 and other devices, including the remote display device instance 240(2). Persons skilled in the art will recognize that many technically-feasible techniques exist for building network 250, including technologies practiced in deploying an Internet communications network. For example, network 250 may include a wide-area network (WAN), a local-area network (LAN), and/or a wireless (Wi-Fi) network, among others.

### The Face Motion Detector Application

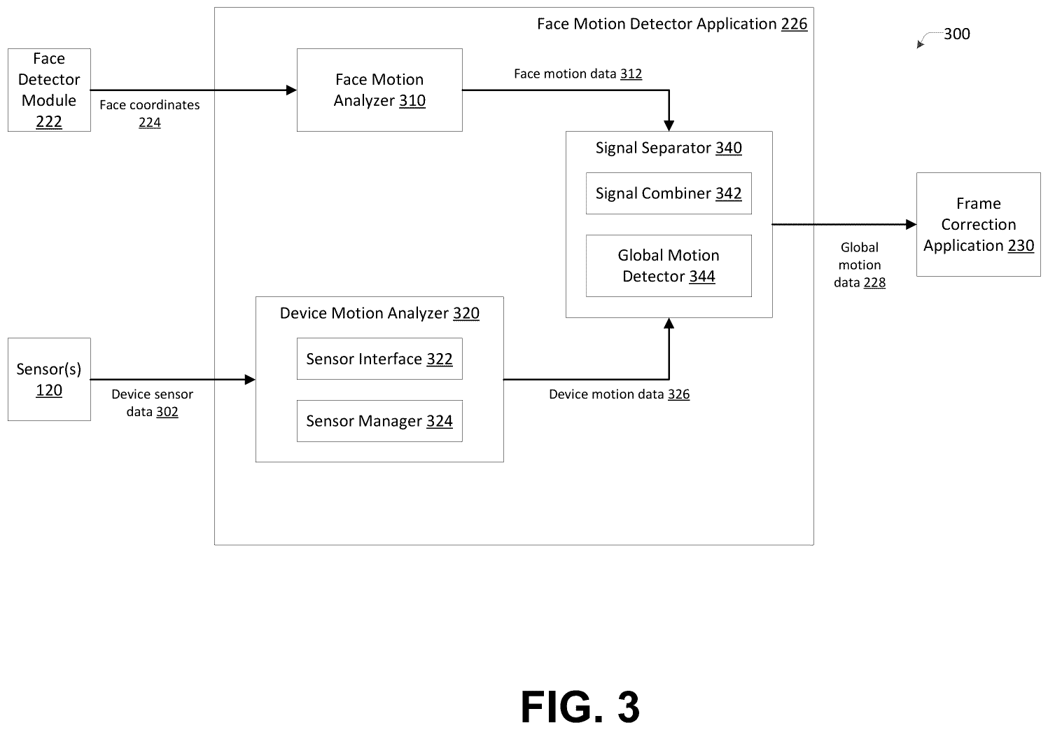

FIG. 3 illustrates a global motion detection technique of the face motion detection application 226 of the image processing system 100 of FIG. 1 detecting motions of subjects and devices, according to one or more embodiments. As shown, and without limitation, the global motion detection technique 300 includes the face detector module 222, sensor(s) 120, the face motion detection application 226, and the frame correction application 230. The face motion detection application 226 includes a face motion analyzer 310, a device motion analyzer 320, and a signal separator 340. The device motion analyzer 320 includes a sensor interface 322 and a sensor manager 324. The signal separator includes a signal combiner 342 and a global motion detector 344.

In operation, the face motion detection application 226 receives the set of face coordinates 224 included in a current frame 152(n) and device sensor data 302 associated with the current frame 152(n) as inputs. The face motion analyzer 310 determines whether the face coordinates 224 in the current frame 152(n) have moved relative to sets of face coordinates from one or more previous frames. The face motion analyzer 310 generates face motion data 312 that indicates whether any face motion is present in the current frame 152(n). Here, face motion present in the current frame 152(n) includes determining that a detected face has moved between consecutive frames 152.

The device motion analyzer 320 receives device sensor data 302 that is generated by the sensors 120 coincident with the image capture device 210 acquiring the visual sensor data for the current frame 152(n). The device motion analyzer 320 determines whether any device motion is present in the current frame 152(n) and generates device motion data 326 that includes a device motion value that is included in the current frame 152(n). The signal separator 340 receives the respective face motion data 312 and the device motion data 326 and generates the global motion data 228 that includes values for any face motion and/or device present in the current frame 152(n). In some embodiments, the global motion data 228 may include a modified set of face coordinates that replace the set of face coordinates that the face detector module 222 generates. Alternatively, the global motion data 228 may omit any sets of face coordinates 224.

The face motion analyzer 310 receives the set of face coordinates 224 from the face detector module 222 and outputs a set of face motion data 312. In some embodiments, the face motion analyzer 310 can cause the face motion detection application 226 to generate a more stable and accurate set of face coordinates based on the received set of face coordinates 224. For example, the face motion analyzer 310 can compare the set of face coordinates 224 for a given face included in the current frame 152(n) (e.g., face coordinates 224(n)) to a set of face coordinates from the previous frame (e.g., face coordinates 224(n−1)) to determine whether the current frame 152(n) includes a valid face motion. Based on the determination of a valid face motion, the face motion analyzer 310 can generate face motion data 312 that includes the face coordinates 224(n) and one or more values associated with the valid face motion.

The device motion analyzer 320 generates device motion data 326 based on receiving input data from one or more sources that indicate device movement is included in the current frame 152(n). Here, the device motion analyzer 320 determines that device motion is in a given frame 152 by determining that the image capture device 210 was moving when acquiring the visual sensor data that is included in the current frame 152(n). In various embodiments, the sensor interface 322 receives the device sensor data 302 from the sensor(s) 120 and the sensor manager 324 processes the device sensor data 302 received via the sensor interface 322 to generate a per-frame device motion value for the current frame 152(n). In various embodiments, the device motion analyzer 320 generates device motion data 326 that includes the per-frame device motion value for the current frame 152(n).

In various embodiments, sensor interface 322 receives the device sensor data 302 from the sensors 120 that correspond to the sensor data generated at the time the image capture device 210 captured the current frame 152(n). For example, the sensor interface 322 can receive rotational axis values (e.g., pitch, roll, yaw) from an accelerometer that is included in the device containing the image capture device 210. In some embodiments, the sensor interface 322 may receive other sensor data, such as sound data from one or more audio sensors, timing and/or other sensor data from laser sensors, and so forth. Additionally or alternatively, the device motion analyzer 320 may receive information from other components in the image processing application 140 and/or other applications. For example, the device motion analyzer 320 could receive scene change data from a scene change detector included in the image processing application 140.

In various embodiments, the sensor manager 324 generates the device motion data 326 based on the received device sensor data 302. In various embodiments, the sensor manager 324 generates device motion data 326 that includes an indication of whether any device motion was detected for the current frame 152(n). In some embodiments, the sensor manager 324 can process the received device sensor data 302 and generate a set of per-frame device motion values corresponding to the current frame 152(n). For example, upon receiving the rotational axis values from the accelerometer, the sensor manager 324 can generate a set of per-frame motion values that indicate the change in each respective rotational axis value from the previous frame. In some embodiments, the sensor manager 324 may combine and normalize the per-frame device motion values into a single device motion value that indicates whether the current frame 152(n) includes device motion and the amount of device motion that occurred. For example, upon generating separate per-motion values for each rotational axis, the sensor manager 324 could normalize the respective values and combine the values into a single rotational change value indicating the total degree of change the image capture device 210 moved relative to the previous frame 152(n−1).

Additionally or alternatively, the sensor manager 324 may determine other device motion data 326. For example, the sensor manager 324 can process ultrasound data, GPS data, and so forth to determine a per-frame change in position relative to the previous frame 152(n−1). In such instances, the sensor manager 324 could generate a positional change value and include the positional change value in the device motion data 326. In another example, the sensor manager 324 could combine the positional change value with the rotational change value to generate a single device movement value. In such instances, the device movement value can indicate device movement when the sensor manager computes a non-zero device movement value.

The signal separator 340 determines the accuracy of the face motion data 312 based on the values provided by the face motion analyzer 310 and the device motion analyzer 320. In various embodiments, the signal combiner 342 receives the face motion data 312 and the device motion data 326 and determines whether to retain, modify, or discard the set of face coordinates 224 received from the face detector module 222. In various embodiments, the signal combiner 342 checks the face coordinates 224 relative to other face motion data 312 and the device motion data 326 in order to determine whether to modify the area defined by the set of face coordinates 224. For example, the signal combiner 342 can modify the set of face coordinates 224 to define a smaller area in order to shrink the area of the current frame 152(n) that identifies a face. In such instances, the signal separator 340 can generate global motion data that includes the modified set of face coordinates in order to cause the frame correction application 230 to modify the current frame based on a larger portion of the current frame 152(n) outside of the area defined by the face coordinates.

The global motion detector 344 generates a set of global motion data 228 that indicates the presence of face motion and/or device motion in the current frame 152(n). In such instances, the frame correction application 230 can modify the current frame 152(n) based on the values included in the global motion data 228. In some embodiments, the global motion detector 344 can generate the global motion data 228 as a data set that includes separate Boolean values indicating the respective presence of face motion and device motion in the current frame 152(n) (e.g., isFaceMovement=Y; isDeviceMovement=N). In other embodiments, the global motion detector 344 can include specific values that specify a quantity or percentage of face motion or device motion that is present in the current frame. Additionally or alternatively, the global motion detector can include the set of face coordinates provided by the signal combiner.

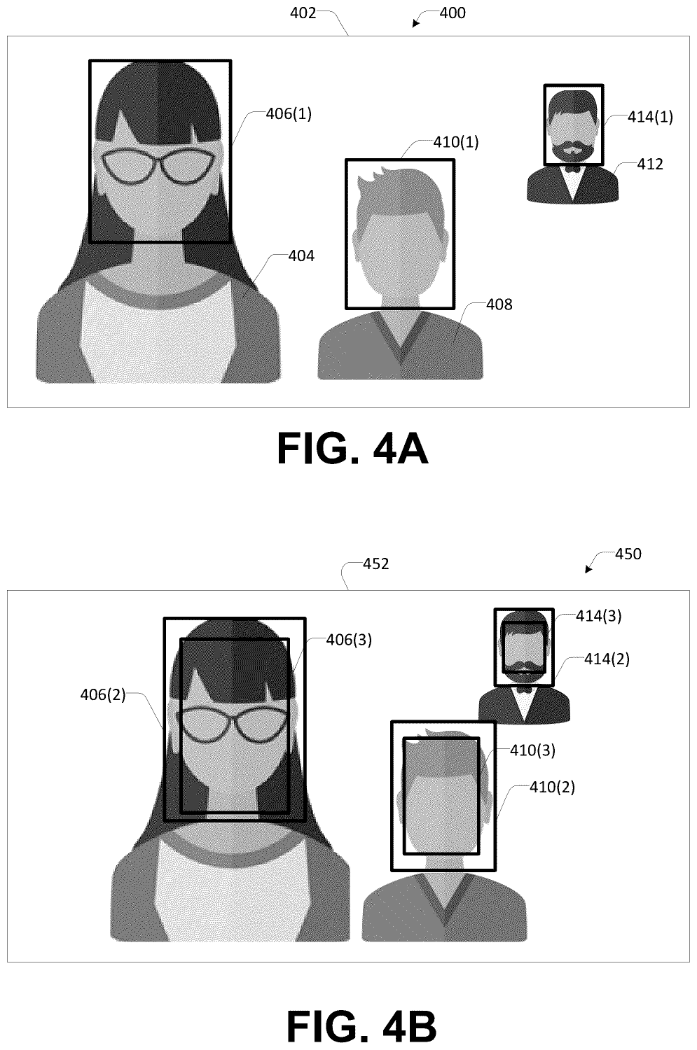

FIGS. 4A-4B illustrate a set of face coordinates generated by the face detection module included in the image processing system 100 of FIG. 1, according to one or more embodiments. FIG. 4A illustrates a first time 400 in a frame sequence. As shown, and without limitation, the first time 400 includes a first frame 402 that includes subjects 404, 408, 412. The first frame 402 includes face regions-of-interest (ROIs) 406, 410, 414.

The first frame 402 is generated from a first set of visual sensor data that the image capture device 210 at a specific time (e.g., t₁). In various embodiments, the face detector module 222 processes the first frame 402 and generates three sets of face coordinates that define separate face ROIs 406, 410, 414 for the detected faces in the first frame 402. For example, the face detector module 222 can generate a set of face coordinates 224 that define the corners of the rectangle of the face ROI 406(1) for the face of the subject 404. In various embodiments, the face detector module 222 can generate separate sets of face coordinates for the detected face of each subject 404, 408, 412 included in the frame.

In various embodiments, the face motion detection application 226 can also acquire the device sensor data 302 and determine positional device values and/or rotational device values at the specific time that the image capture device 210 acquired the visual sensor data. In some embodiments, the device motion analyzer 320 can process the device sensor data 302 in parallel with the face detector module 222 generating the sets of face coordinates 224 used to define the face ROIs 406, 410, 414.

FIG. 4B illustrates a second time 450 in the frame sequence. As shown, and without limitation, the first time 400 includes a second frame 452 that includes updated face (ROIs) 406, 410, 414. The second frame 452 is generated from a second set of visual sensor data that the image capture device 210 at a specific time after the first time (e.g., t₂). In various embodiments, the second time may be based on a specific frame rate (e.g., t₂ occurring 1 second after t₁ when the image capture device 210 is recording at a 60 frames-per-second frame rate). In the second frame 452, each subject 404, 408, 412 has moved relative to the previous position. As a result, each face ROI 406(2), 410(2), 414(2) has moved relative to their respective positions in the first frame 402.

In various embodiments, the face motion analyzer 310 can compare the sets of face coordinates 224 corresponding to the second frame 452 with the sets of frame coordinates corresponding to the first frame 402 in order to determine whether second frame 452 includes any face motions (e.g., whether a face moved in the period of t₂−t₁). In some embodiments, the face motion analyzer 310 can compute an impact factor value that indicates the relative amounts of face motion included in the second frame 452. For example, the face motion analyzer 310 can determine the relative size of a face by comparing the area of the face ROI to the entire frame. For example, the face motion analyzer 310 can determine a relative face size for 406(2) compared to the second frame 452. The face motion detector can also determine that the relative face sizes have descending values from the face ROI 406(2) to the face ROI 410(2) to the face ROI 414(2).

The face motion analyzer 310 can also generate the face motion data 312 by computing for each face ROI 406, 410, 414 an intersection over union (IoU) value that indicates the relative amount of overlap of a given ROI 406, 410, 414 between consecutive frames. For example, the face motion analyzer 310 could determine an area of overlap and an area of union between the face ROI 406(1) in the first frame 402 and the face ROI 406(2) in the second frame 452. The face motion analyzer 310 could compute the IoU value to determine the amount a given face moved between frames (e.g., the amount of face motion in the second frame 452).

In various embodiments, the face motion detection application 226 can also acquire the device sensor data 302 and determine positional device values and/or rotational device values at the second time. In some embodiments, the device motion analyzer 320 can process the device sensor data 302 in parallel with the face motion analyzer 310 generating the face motion data 312. In some embodiments, the signal combiner 342 can shrink one or more of the face ROIs 406, 410, 414 when the device motion data 326 indicates a large amount of device motion in the second frame 452. In such instances, the signal combiner 342 can shrink the face ROIs 406(2), 410(2), 414(2) to generate a modified set of face coordinates that define a modified set of face ROIs 406(3), 410(3), 414(3).

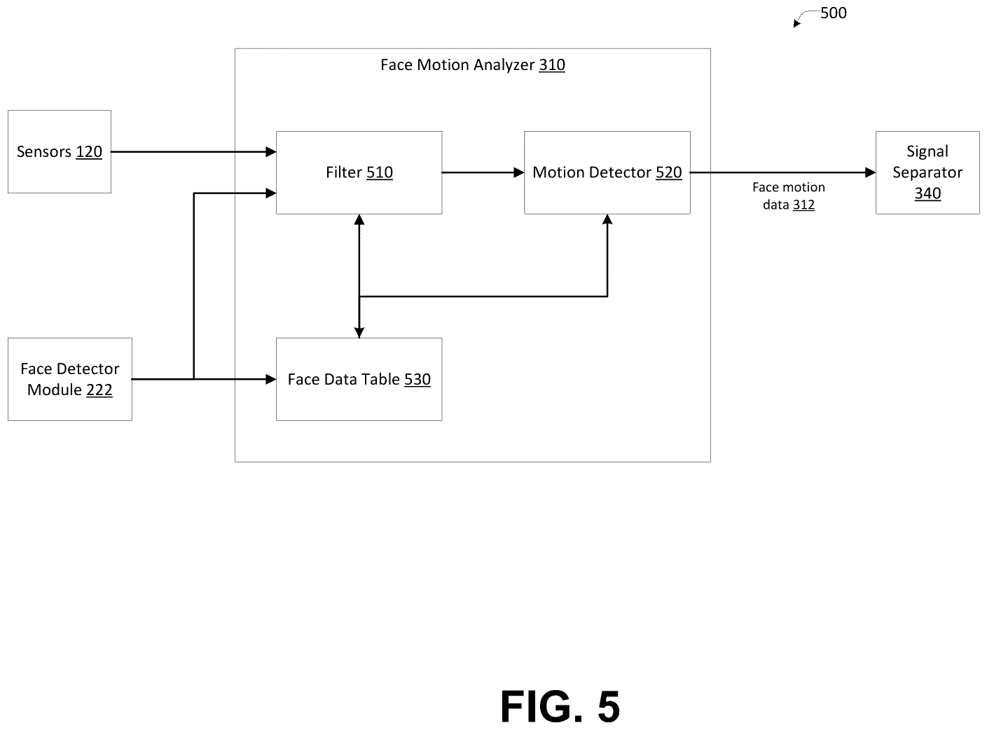

FIG. 5 illustrates a technique 500 of the face motion analyzer 310 of the image processing system 100 of FIG. 1 detecting face motions of subjects in a frame, according to one or more embodiments. As shown, and without limitation, the face detection technique 500 includes sensors 120, the face detector module 222, the face motion analyzer 310, and the signal separator 340. The face motion analyzer 310 includes a filter 510, a motion detector 520, and a face data table 530.

In operation, the face motion analyzer 310 receives the sets of face coordinates 224 from the face detector module 222. The face motion analyzer 310 also receives one or more brightness values from the sensors 120. In some embodiments, the face motion analyzer 310 receives the brightness values from the image capture device 210. The filter 510 compares the sets of face coordinates 224 and with face coordinate data from previous frames and filters the sets of face coordinates 224 when the filter 510 determines that the sets of face coordinates 224 in the current frame 152(n) are not accurate. The motion detector 520 compares the sets of face coordinates 224 provided by the filter with face data from the previous frame 152(n−1) to compute various face motion values. The motion detector 520 generates the face motion data 312 to include the sets of face coordinate data and the computed face motion values.

In various embodiments, the filter 510 is a temporal filter that compares face data in the current frame 152(n) with face data from one or more previous frames (e.g., 152(n−1), 152(n−2), etc.) and filters out any face data that is considered to be invalid or inaccurate. In some embodiments, the filter 510 can receive various sensor data from the sensors 120 and/or image parameter values associated with the current frame 152(n). For example, the filter 510 can receive a set of brightness values from the sensor 120. The filter 510 also receives the sets of face coordinates 224 from the face detector module 222. In some embodiments, the filter 510 updates the face data table 530 by adding one or more entries that include the sets of face coordinates 224 and the brightness levels for the frame. For example, the filter may include separate entries for the consecutive frames of 152(n−2), 152(n−1) that immediately preceded the current frame 152(n).

In various embodiments, the filter 510 can compute a difference between the brightness of the current frame 152(n) with an average brightness of a set of previous frames. The filter 510 can also compare the brightness difference to a threshold to determine whether the brightness in the current frame 152(n) indicates an error in the frame (e.g., lens flare, loss of light etc.). In such instances, the filter 510 can filter out any sets of face coordinates 224 generated by the face detector module 222 by setting all the sets of face coordinates to zero. Otherwise, the filter 510 forwards the sets of face coordinates to the motion detector 520.

As discussed above in relation to FIGS. 4A-4B, in various embodiments, the motion detector 520 can determine any face motion present in the current frame 152(n) by comparing the sets of face coordinates 224 received from the filter 510 with the sets of face coordinates present in the previous frame 152(n−1). In some embodiments, the motion detector 520 can retrieve from the face data table 530 the sets of face coordinates from the previous frame 152(n−1). For each face ROI defined by a set of face coordinates 224 in the current frame, the motion detector computes an IoU value that indicates a relative amount of change between frames, where smaller IoU values indicate larger face movements between frames.

In various embodiments, the motion detector 520 can compute an impact factor value that indicates the relative amounts of face motion included in the current frame 152(n). For example, the face motion analyzer 310 can determine the relative sizes of each face in the current frame 152(n). The motion detector 520 can then compute the impact factor value for the current frame 152(n) based on the computed IoU value:

ImpactFactor==ₓ₌₁ⁿ(1−IoU_{fx})RFS (1)

Where IoU_{fx} is the IoU value for a given face ROI defined by a set of face coordinates 224 and RFS is a relative face size of the given face ROI compared to the size of the current frame 152(n). In some embodiments, the motion detector 520 can compare the impact factor value with a face motion threshold value in order to determine whether any computed face motions in the current frame 152(n) are significant. In some embodiments, the face motion detection application 226 can modify the face motion threshold to adjust the sensitivity of the motion detector 520. When the motion detector 520 determines that the impact factor value exceeds the face motion threshold, the motion detector 520 generates face motion data 312 that includes an indication of face motion present in the current frame 152(n) (e.g., isFaceMovement=T); otherwise, when the motion detector 520 determines that the impact factor value does not exceed the face motion threshold, the motion detector 520 generates face motion data 312 that includes an indication of no face motion present in the current frame 152(n) (e.g., isFaceMovement=F).

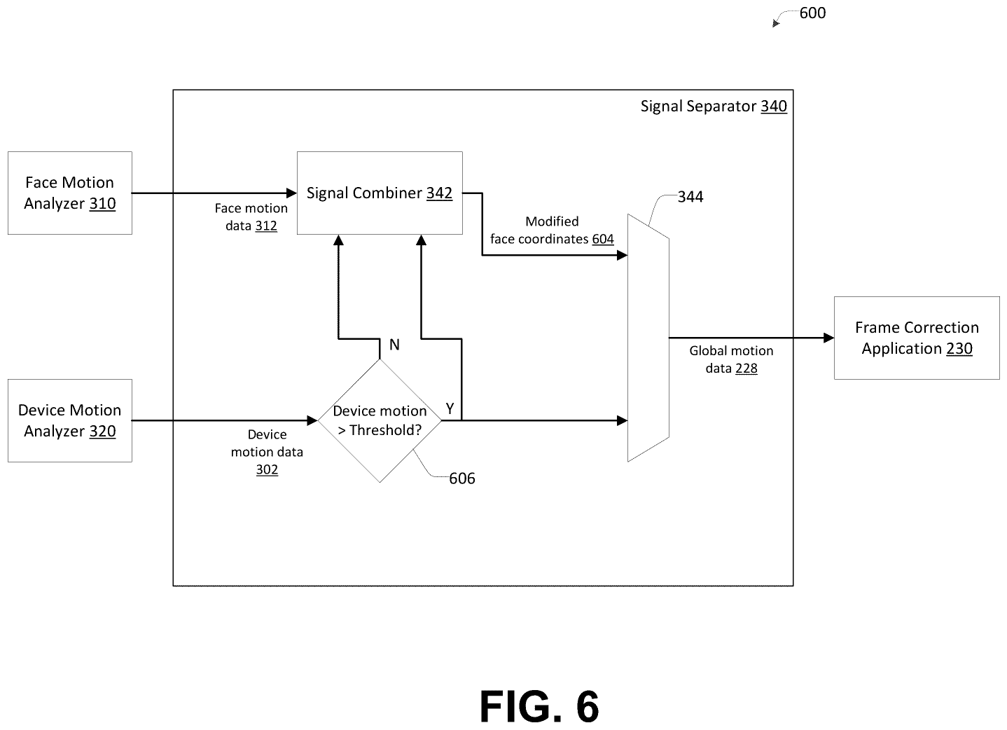

FIG. 6 illustrates a technique of the signal separator 340 of the image processing system 100 of FIG. 1 determining whether a global motion has occurred, according to one or more embodiments. As shown, the global motion data generation technique 600 includes the face motion analyzer 310, the device motion analyzer 320, the signal separator 340, and the frame correction application 230. The signal separator includes the signal combiner 342, the global motion detector 344, and a device motion detector 606.

In operation, the signal separator 340 receives the face motion data 312 from the face motion analyzer 310 and the device motion data 326 from the device motion analyzer 320. The device motion detector 606 compares the values included in the device motion data 326 to a device motion threshold to determine whether a significant amount of device motion is in the current frame 152(n). The device motion detector 606 generates an indication for the presence or absence of device motion in the current frame 152(n) (e.g., isDeviceMotion=T/F) and transmits the values to the signal combiner 342. The signal combiner 342 generates modified sets of face coordinates 604 based on the device motion indication provided by the device motion detector 606. The global motion detector 344 receives the modified sets of face coordinates 604 and the device motion indication from the device motion detector 606 and generates the global motion data 228 for the frame correction application 230.

In various embodiments, the signal combiner 342 determines whether to shrink the given face ROI included in the current frame 152(n), where the signal combiner 342 computes the amount to modify the face ROI (e.g., shrink percentage) as a function of both the size of the device motion value and the impact factor value included in the face motion data 312.

S=f(DM,ImpactFactor) (2)

Where S is the shrink percentage and DM is the device motion value.

For example, the signal combiner 342 can receive a high device motion value from the device motion data 326. In such instances, the signal combiner 342 can determine that the face motion data 312 received from the face motion analyzer 310 is not accurate. The signal combiner 342 could then generate the modified set of face coordinates 604 such that the face ROIs defined by the modified set of face coordinates 604. to occupy a smaller area.

The global motion detector 344 generates the set of global motion data 228. In various embodiments, the global motion detector 344 includes in the global motion data 228 separate indications of whether the current frame 152(n) includes face motion or device motion. In such instances, the global motion data 228 indicates whether any face motion included in the current frame 152(n) is unique motion, or due to a global motion associated with the image capture device 210.

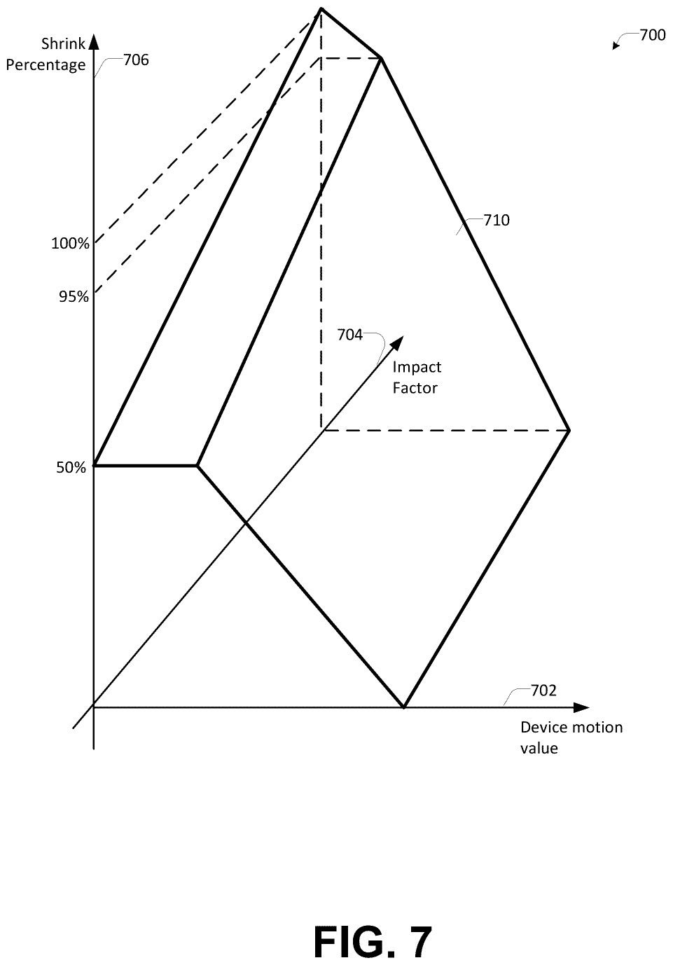

FIG. 7 illustrates a graph generated by a signal combiner 342 included in the image processing system 100 of FIG. 1 used to determine a shrinking percentage for a frame, according to one or more embodiments. As shown, the graph 700 includes a first axis 702 for a device motion value, a second axis 704 for an impact factor, and a third axis 706 for a shrink percentage, and a shrink percentage value 710.

In various embodiments, the signal combiner 342 determines the shrink percentage value 710 as a function of both a device motion value provided by the device motion analyzer 320 and an impact factor provided by the face motion analyzer 310. In some embodiments, the curve of the shrink percentage value 710 may be tunable with respect to the device motion value and/or the impact factor value.

The signal combiner 342 computes larger shrink percentages in order to shrink the face ROI in greater amounts. In such instances, the modified face ROIs occupy a smaller portion of the current frame 152(n) and may change how the frame correction application 230 generates a modified current frame 154(n) that corresponds to the current frame 152(n).

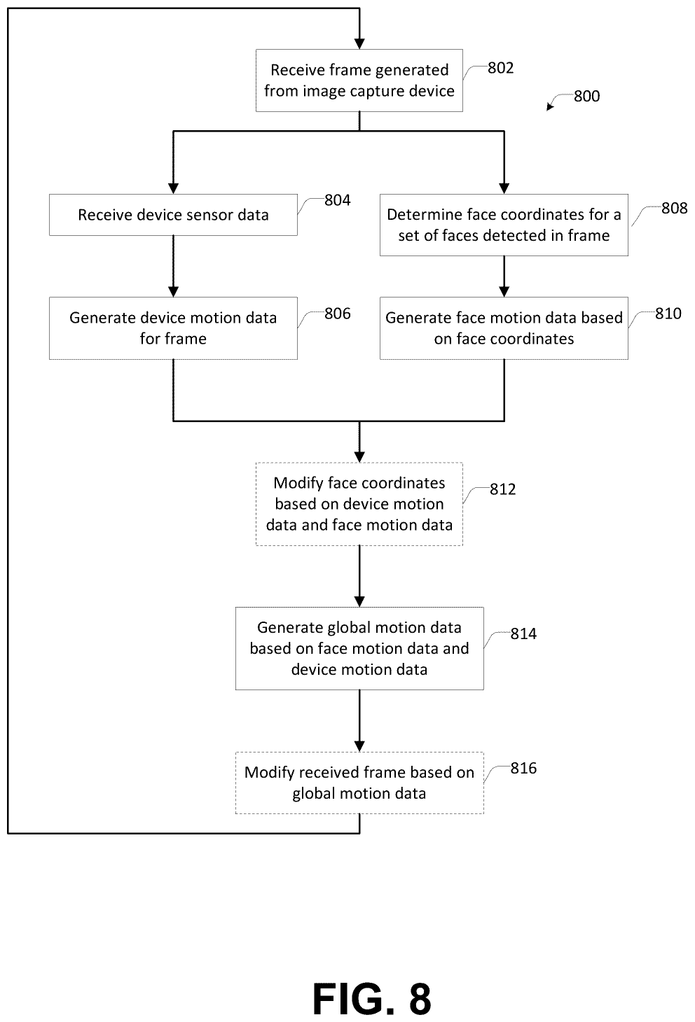

FIG. 8 is a flow diagram of method steps of the image processing system of FIG. 1 modifying a captured video frame, according to one or more embodiments. Although the method steps are described with reference to the systems and call flows of FIGS. 1-6, persons skilled in the art will understand that any system configured to implement the method steps, in any order, falls within the scope of the present disclosure.

Method 800 begins at step 802, where the image processing application 140 receives a frame generated by the image capture device 210. In various embodiments, one or more components included in the image processing application 140 receives a current frame 152(n) captured by the image capture device 210. In some embodiments, the image processing application 140 periodically receives a current frame 152(n) in a sequence of video frames 152. In such instances, the image processing application 140 can store frame data (including face data and/or device movement data) for previous frames and may compare the current frame 152(n) to one or more previous frames in order to generate image correction parameter values to modify the received frame.

At step 804, the image processing application 140 receives the device sensor data 302 from one or more sensors 120. In various embodiments, a face motion detection application 226 included in the image processing application 140 receives device sensor data 302 from the sensors 120 that correspond to the sensor data that the sensors 120 acquired at the time the current frame 152(n) was captured. For example, a device motion analyzer 320 included in the face motion detection application 226 can receive rotational axis values (e.g., pitch, roll, yaw) from an accelerometer via the sensor interface 322.

In some embodiments, the sensor interface 322 may receive other sensor data, such as sound data from one or more audio sensors, data from laser sensors, and so forth. Alternatively, the device motion analyzer 320 may receive information from other components in the image processing application 140 and/or the video capture device 210. For example, the device motion analyzer 320 can receive scene change data from a scene change detector included in the image processing application 140.

At step 806, the image processing application 140 generates device motion data. In various embodiments, the device motion analyzer 320 generates device motion data 326 that includes an indication of whether any device motion was detected for the current frame 152(n). For example, a sensor manager 324 included in the device motion analyzer 320 can process the device sensor data 302 and generate a set of per-frame device motion values corresponding to the current frame 152(n). In some embodiments, the device motion analyzer 320 can combine and normalize the per-frame device motion values into a single device motion value that indicates whether the current frame 152(n) includes device motion and the amount of device motion that occurred.

At step 808, the image processing application 140 determines face coordinates 224 for a set of faces included in the current frame 152(n). In various embodiments, a face detector module 222 included in the image processing application 140 receives the current frame 152(n) generated by the image capture device 210 and identifies a set of faces included in the current frame 152(n). Additionally or alternatively, the face detector module 222 may generate the face coordinates 224 in parallel with the device motion analyzer 320 generating the device motion data 326. For each detected face, the face detector module 222 generates a set of face coordinates 224 for each detected face. In some embodiments, the face detector module 222 may not detect any faces within the current frame 152(n). In such instances, the face detector module 222 provides an indication to the frame correction application that the current frame 152(n) does not include any face coordinates 224.

At step 810, the image processing application 140 generates face motion data based on the sets of face coordinates. In various embodiments, a face motion detection application 226 included in the image processing application 140 generates the face motion data 312 that includes information indicating whether the detected faces within the current frame 152(n) moved relative to a previous frame. Additionally or alternatively, the face detector module 222 may generate the face coordinates 224 in parallel with the device motion analyzer 320 generating the device motion data 326.

In various embodiments, a face motion analyzer 310 included in the face motion detection application 226 receives the face coordinates 224 from the face detector module 222. In some embodiments, the face motion analyzer 310 stores the sets of face coordinates 224 for each frame in the face data table 530. The face motion analyzer 310 uses a motion detector 520 to determine whether the face coordinates 224 in the current frame 152(n) moved relative to the face coordinates from the previous frame 152(n−1). In some embodiments, the face motion analyzer 310 may include a filter 510 that compares the brightness of the current frame 152(n) to a threshold. In such instances, the filter 510 may remove the face coordinates 224 from a frame when the brightness of the current frame 152(n) relative to previous frames exceeds a threshold.

In some embodiments, the motion detector 520 computes an impact factor value that indicates the amount of face motion in the current frame 152(n). In such instances, the face motion detection application 226 can modify the sets of face coordinates 224 based on the computed impact factor in order to adjust the portion of the current frame 152(n) that includes the face coordinates 224.

At step 812, the image processing application 140 optionally modifies the sets of face coordinates based on the device motion data and the face motion data. In various embodiments, a signal separator 340 included in the face motion detection application 226 can receive face motion data 312 from the face motion analyzer 310 and device motion data from the device motion analyzer 320. A signal combiner 342 included in the signal separator 340 determines whether to shrink the area of a given set of face coordinates as a function of both the size of the device motion value and the impact factor value. In such instances, the face motion detection application 226 may shrink the area of the face coordinates in order to reduce the area of the current frame 152(n) that is occupied by a given face. For example, the signal combiner 342 can receive a high device motion value from the device motion analyzer 320. In such instances, the signal combiner can determine that the face motion data received from the face motion analyzer 310 is not accurate and can alter the face coordinates associated with the received frame 152(2) to occupy a smaller area.

At step 814, the image processing application 140 generates a set of global motion data based on the device motion data 326 and the face motion data 312. In various embodiments, a global motion generator included in the signal separator generates a set of global motion data that indicates whether any face motion included in the current frame 152(n) is unique. In some embodiments, the global motion detector 344 generates the global motion data 228 to include separate values including (i) an indication of whether any face motion was detected in the current frame 152(n), (ii) an indication of whether any device motion was detected in the current frame 152(n), and (iii) sets of face coordinates corresponding to each face detected in the current frame 152(n). In some embodiments, the global motion detector 344 receives the sets of modified face coordinates 604 from the signal combiner 342. In such instances, the global motion detector 344 includes the set of modified face coordinates in lieu of the sets of face coordinates 224 generated by the face detector module 222.

At step 816, the image processing application 140 can optionally modify the current frame 152(n) based on the global motion data 228. In various embodiments, the frame correction application 230 can receive the global motion data 228 from the face motion detection application 226 and generate a set of image correction parameter values to modify the image parameters for the current frame 152(n) to generate a modified current frame 154(n).

In some embodiments, the frame correction application 230 can, upon receiving the global motion data 228, determine that the image capture device 210 moved when generating the current frame 152(n). In such instances, the frame correction application 230 can generate the image correction parameter values based on the image parameters included in the entire frame. Additionally or alternatively, the frame correction application 230 can control the convergence speed of a sequence of frames 152 to a steady-state level based on whether the global motion data 228 indicates whether the frame 152 includes device motion. In such instances, the frame correction application 230 may generate image correction parameter values that cause faster convergence speeds when the face motion detection application 226 detects device motion in the current frame 152(n).

For example, the auto exposure module 232 included in the frame correction application 230 could, in response to the global motion data 228 indicating that the current frame 152(n) includes device motion, generate a brightness adjustment value based on the brightness range of the entire frame. In another example, the auto white balance module 234 included in the frame correction application 230 may, in response to the global motion data 228 indicating that the current frame 152(n) does not include device motion, generate a color adjustment values by weighing the color values within the sets of face coordinates more heavily than other portions of the current frame 152(n). In some embodiments, the image processing application 140 sends the modified current frame 154(n) to one or more display devices 240.

In sum, an image processing application included in a video processing device identifies motion in one or more subjects of a video frame and determines whether such motion in the one or more subjects is a unique motion or is a part of a global motion that also includes motion of the video capture device. In particular, for each frame captured by the image capture device, a face motion detection application included in the image processing application receives a set of face coordinates that correspond to each detected face in the current frame. The face motion detection module also receives device data associated with the position and/or movement of the video capture device when capturing the current frame. A face motion analyzer included in the face motion detection application compares the face coordinates of the current frame to face coordinates of the previous frame to determine whether the face moved a significant amount between frames. A device motion analyzer also included in the face motion detection application independently determines whether the video capture device has moved significantly between frame captures.

When the face motion detector application determines that the video capture device has moved, the face motion detector application determines that the detected face motion is at least partially due to the device motion. In such instances, the face motion detector application modifies the face coordinates for the detected faces associated with the current frame; otherwise, when the face motion detector application determines that the frame includes unique face motions, the face motion detector application maintains the detected face coordinates. The face motion detector application can provide a set of global motion data that includes the face coordinates, the face motion determination, and/or the device motion determination, to other components of the image processing application, such as a frame correction application that performs image correction techniques on the frame based on the global motion values.

At least one technological advantage of the disclosed techniques relative to the prior art is that the image processing application enables a video processing device to distinguish movements of faces in a video frame to movements of the device capturing the video frame. In particular, by determining the movements of detected faces in a sequence of video frames and separately determining device motions that occurred when capturing the sequence of video frames, the image processing application can identify unique face motions in a video frame compared to global motions that are also due to the image capture device moving. The image processing application thus filters false positive face movements and can perform correction operations based on whether a unique face motion is detected. The image processing application can perform correction operation therefore that edit frames with more accurate face motion data. The image processing application can avoid overcorrecting or under-correcting image parameters when editing a given video frame. Accordingly, a video processing device incorporating the image processing application will converge to steady-state levels for various image parameters in fewer video frames and in less time than in conventional image correction techniques. These technical advantages provide one or more technological advancements over prior art approaches.
1. In various embodiments, a computer-implemented method comprises generating, for a current video frame, a set of face motion data indicating whether a set of one or more faces detected in the current video frame has moved since a preceding video frame, generating a set of device motion data associated with one or more movements of an image capture device when capturing the current video frame, and generating a set of global motion data based on the set of face motion data and the set of device motion data, where the set of global motion data identifies a unique face motion when the set of face motion data indicates at least one face in the set of one or more faces has moved, and the set of device motion data indicates less than a threshold amount of motion of the image capture device when capturing the current video frame.
2. The computer-implemented method of clause 1, further comprising modifying the current video frame based on the set of global motion data to generate a modified current video frame.
3. The computer-implemented method of clause 1 or 2, where generating the modified current video frame comprises generating a set of image correction parameter values, and applying the set of image correction parameter values to the current video frame.
4. The computer-implemented method of any of clauses 1-3, where at least one image parameter value in the set of image correction parameter values differs based on the identification of the unique face motion in the set of global motion data.
5. The computer-implemented method of any of clauses 1-4, wherein generating the set of face motion data comprises generating a set of difference values between a set of face coordinates in the current video frame with a set of face coordinates in the preceding video frame, and computing an impact factor value for the current video frame based on the set of difference values.
6. The computer-implemented method of any of clauses 1-5, further comprising modifying the set of face coordinates in the current video frame to generate a modified set of face coordinates, where modifying the set of face coordinates is based on at least one of the impact factor value or the set of device motion data.
7. The computer-implemented method of any of clauses 1-6, further comprising generating, for each face in the set of one or more faces, a set of difference values between a set of face coordinates in the current video frame with a set of face coordinates in the preceding video frame, and generating a set of relative face sizes, and computing an impact factor value for the current video frame, wherein the impact factor value is based on the sets of difference values and the set of relative face sizes.
8. The computer-implemented method of any of clauses 1-7, where generating a set of device motion data comprises receiving sensor data from one or more sensors associated with the image capture device at a time the image capture device captured the current video frame, and computing a device movement value based on the sensor data.
9. The computer-implemented method of any of clauses 1-8, further comprising computing a brightness difference value for the current video frame with an average brightness value for a sequence of preceding video frames, comparing the brightness difference value to a brightness difference threshold, and discarding a set of face coordinates in the current video frame when the brightness difference value is above a brightness threshold.
10. The computer-implemented method of any of clauses 1-9, further comprising determining that a unique face motion is present in the current video frame, upon determining that a unique face motion is present, generating a set of image correction parameter values based on one or more sets of face coordinates associated with the set of one or more faces, and applying the set of image correction parameter values to the current video frame.
11. In various embodiments, one or more non-transitory computer-readable media store instructions that, when executed by one or more processors, cause the one or more processors to perform the steps of generating, for a current video frame, a set of face motion data indicating whether a set of one or more faces detected in the current video frame has moved since a preceding video frame, generating a set of device motion data associated with one or more movements of an image capture device when capturing the current video frame, and generating a set of global motion data based on both the set of face motion data and the set of device motion data, where the set of global motion data identifies a unique face motion when the set of face motion data indicates at least one face in the set of one or more faces has moved, and the set of device motion data indicates less than a threshold amount of motion of the image capture device when capturing the current video frame.
12. The one or more non-transitory computer-readable media of clause 11, further storing instructions that, when executed by the one or more processors, cause the one or more processors to perform the steps of generating a set of image correction parameter values based on the set of global motion data, and applying the set of image correction parameter values to the current video frame to generate a modified current video frame.
13. The one or more non-transitory computer-readable media of clause 11 or 12, where generating the set of image correction parameter values comprises performing at least one of an automatic exposure operation or performing an automatic white balance operation on a set of image parameters associated with the current video frame.
14. The one or more non-transitory computer-readable media of any of clauses 11-13, where generating a set of device motion data comprises receiving a scene change indication associated with the current video frame, and generating a device movement value based on the scene change indication.
15. The one or more non-transitory computer-readable media of any of clauses 11-14, where generating a set of device motion data comprises receiving sensor data from one or more sensors associated with the image capture device at a time the image capture device captured the current video frame, and computing a device movement value based on the sensor data.
16. In various embodiments, a system comprises a memory storing an image processing application, and a processor that executes the image processing application by performing the steps of generating, for a current video frame, a set of face motion data indicating whether a set of one or more faces detected in the current video frame has moved since a preceding video frame, generating a set of device motion data associated with one or more movements of an image capture device when capturing the current video frame, and generating a set of global motion data based on both the set of face motion data and the set of device motion data, where the set of global motion data identifies a unique face motion when the set of face motion data indicates at least one face in the set of one or more faces has moved, and the set of device motion data indicates less than a threshold amount of motion of the image capture device when capturing the current video frame.
17. The system of clause 16, further comprising modifying the current video frame based on the set of global motion data to generate a modified current video frame.
18. The system of clause 16 or 17, further comprising one or more sensors associated with the image capture device that acquire sensor data at a time the image capture device captured the current video frame, where the processor further executes the image processing application by performing the step of computing a device movement value based on the sensor data.
19. The system of any of clauses 16-18, where the one or more sensors include at least one of an accelerometer, a sound sensor, or a laser sensor.
20. The system of any of clauses 16-19, further comprising a display device that displays one or more frames, where the processor further executes the image processing application by performing the steps of modifying the current video frame based on the set of global motion data to generate a modified current video frame, and causing the display device to display the modified current video frame.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method, comprising:
generating, for a current video frame, a set of face motion data indicating whether a set of one or more faces detected in the current video frame has moved since a preceding video frame;
generating a set of device motion data associated with one or more movements of an image capture device when capturing the current video frame; and
generating a set of global motion data based on the set of face motion data and the set of device motion data, wherein the set of global motion data identifies a unique face motion when:
the set of face motion data indicates at least one face in the set of one or more faces has moved, and
the set of device motion data indicates less than a threshold amount of motion of the image capture device when capturing the current video frame.

2. The computer-implemented method of claim 1, further comprising modifying the current video frame based on the set of global motion data to generate a modified current video frame.

3. The computer-implemented method of claim 2, wherein generating the modified current video frame comprises:
generating a set of image correction parameter values; and
applying the set of image correction parameter values to the current video frame.

4. The computer-implemented method of claim 3, wherein at least one image parameter value in the set of image correction parameter values differs based on the identification of the unique face motion in the set of global motion data.

5. The computer-implemented method of claim 1, wherein generating the set of face motion data comprises:
generating a set of difference values between a set of face coordinates in the current video frame with a set of face coordinates in the preceding video frame; and
computing an impact factor value for the current video frame based on the set of difference values.

6. The computer-implemented method of claim 5, further comprising:
modifying the set of face coordinates in the current video frame to generate a modified set of face coordinates,
wherein modifying the set of face coordinates is based on at least one of the impact factor value or the set of device motion data.

7. The computer-implemented method of claim 1, further comprising:
generating, for each face in the set of one or more faces, a set of difference values between a set of face coordinates in the current video frame with a set of face coordinates in the preceding video frame; and
generating a set of relative face sizes; and
computing an impact factor value for the current video frame, wherein the impact factor value is based on the sets of difference values and the set of relative face sizes.

8. The computer-implemented method of claim 1, wherein generating a set of device motion data comprises:
receiving sensor data from one or more sensors associated with the image capture device at a time the image capture device captured the current video frame; and
computing a device movement value based on the sensor data.

9. The computer-implemented method of claim 1, further comprising:
computing a brightness difference value for the current video frame with an average brightness value for a sequence of preceding video frames;
comparing the brightness difference value to a brightness difference threshold; and
discarding a set of face coordinates in the current video frame when the brightness difference value is above a brightness threshold.

10. The computer-implemented method of claim 1, further comprising:
determining that a unique face motion is present in the current video frame;
upon determining that a unique face motion is present, generating a set of image correction parameter values based on one or more sets of face coordinates associated with the set of one or more faces; and
applying the set of image correction parameter values to the current video frame.

11. One or more non-transitory computer-readable media storing instructions that, when executed by one or more processors, cause the one or more processors to perform the steps of:
generating, for a current video frame, a set of face motion data indicating whether a set of one or more faces detected in the current video frame has moved since a preceding video frame;
generating a set of device motion data associated with one or more movements of an image capture device when capturing the current video frame; and
generating a set of global motion data based on both the set of face motion data and the set of device motion data, wherein the set of global motion data identifies a unique face motion when:
the set of face motion data indicates at least one face in the set of one or more faces has moved, and
the set of device motion data indicates less than a threshold amount of motion of the image capture device when capturing the current video frame.

12. The one or more non-transitory computer-readable media of claim 11, further storing instructions that, when executed by the one or more processors, cause the one or more processors to perform the steps of:
generating a set of image correction parameter values based on the set of global motion data; and
applying the set of image correction parameter values to the current video frame to generate a modified current video frame.

13. The one or more non-transitory computer-readable media of claim 12, wherein generating the set of image correction parameter values comprises performing at least one of an automatic exposure operation or performing an automatic white balance operation on a set of image parameters associated with the current video frame.

14. The one or more non-transitory computer-readable media of claim 11, wherein generating a set of device motion data comprises:
receiving a scene change indication associated with the current video frame; and
generating a device movement value based on the scene change indication.

15. The one or more non-transitory computer-readable media of claim 11, wherein generating a set of device motion data comprises:
receiving sensor data from one or more sensors associated with the image capture device at a time the image capture device captured the current video frame; and
computing a device movement value based on the sensor data.

16. A system comprising:
a memory storing an image processing application; and
a processor that executes the image processing application by performing the steps of:
generating, for a current video frame, a set of face motion data indicating whether a set of one or more faces detected in the current video frame has moved since a preceding video frame;
generating a set of device motion data associated with one or more movements of an image capture device when capturing the current video frame; and
generating a set of global motion data based on both the set of face motion data and the set of device motion data, wherein the set of global motion data identifies a unique face motion when:
the set of face motion data indicates at least one face in the set of one or more faces has moved, and
the set of device motion data indicates less than a threshold amount of motion of the image capture device when capturing the current video frame.

17. The system of claim 16, further comprising:
modifying the current video frame based on the set of global motion data to generate a modified current video frame.

18. The system of claim 16, further comprising:
one or more sensors associated with the image capture device that acquire sensor data at a time the image capture device captured the current video frame,
wherein the processor further executes the image processing application by performing the step of computing a device movement value based on the sensor data.

19. The system of claim 18, wherein the one or more sensors include at least one of an accelerometer, a sound sensor, or a laser sensor.

20. The system of claim 16, further comprising:
a display device that displays one or more frames,
wherein the processor further executes the image processing application by performing the steps of:
modifying the current video frame based on the set of global motion data to generate a modified current video frame; and
causing the display device to display the modified current video frame.
